(19) United States
(12) Patent Application Publication
(10) Pub. No.: US 2010/0165387 A1
(43) Pub. Date: Jul. 1, 2010

(54) IMAGE-FORMING SYSTEM

(75) Inventor: Wataru MIZUMUKAI, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/635,113

(22) Filed: Dec. 10, 2009

(30) Foreign Application Priority Data
Dec. 25, 2008 (JP) 2008-329357

(51) Int. Cl. G06F 15/00

(52) U.S. Cl. 358/1.15

(57) ABSTRACT

An image-forming system includes a writing unit, an image-forming unit, a determining unit, and a control unit. The writing unit is capable of writing additional data to a first storing unit of a recording medium. The image-forming unit forms an image on the recording medium based on image data. The determining unit determines whether or not the image is normally printed on the recording medium by the image-forming unit. The control unit controls the writing unit to write the additional data to the first storing unit when the determining unit determines that the image is printed normally, and to prevent the additional data from being written to the first storing unit when the determining unit determines that the image is not printed normally.

### CROSS REFERENCE TO RELATED APPLICATION

This application claims priority from Japanese Patent Application No. 2008-329357 filed Dec. 25, 2008. The entire content of this application is incorporated herein by reference.

### TECHNICAL FIELD

The present invention relates to an image-forming system, and particularly to an image-forming system that prints images on a recording medium provided with a storing unit and writes data to the storing unit.

### BACKGROUND

Recently image-forming systems have been developed with functions for printing images on a sheet of paper having an IC chip called a radio frequency identification (RFID) tag and for writing data to the RFID tag. One such image-forming system that has been proposed includes a facsimile transmitting device and a facsimile receiving device.

With this image-forming system, the facsimile transmitting device acquires image data by reading an original document with an attached RFID tag, reads RFID data stored in the RFID tag, and transmits both sets of data to the facsimile receiving device. The facsimile receiving device of the system receives the same types of data, prints an image on a sheet of paper having an attached RFID tag based on the received image data, and writes the received RFID data to the RFID tag attached to the same sheet of paper.

### SUMMARY

However, if a paper jam occurs in the image-forming system described above, the system may be unable to print the corresponding image properly, resulting in a sheet of paper having only RFID data written in the RFID tag. This is undesirable, since the resulting sheet having only RFID data differs from the desired format.

In view of the foregoing, it is an object of the present invention to provide an image-forming system capable of preventing the production of a sheet having only RFID data written in the RFID tag when the image could not be properly formed on the sheet.

In order to attain the above and other objects, the invention provides an image-forming system including a writing unit, an image-forming unit, a determining unit, and a control unit. The writing unit is capable of writing additional data to a first storing unit of a recording medium. The image-forming unit forms an image on the recording medium based on image data. The determining unit determines whether or not the image is normally printed on the recording medium by the image-forming unit. The control unit controls the writing unit to write the additional data to the first storing unit when the determining unit determines that the image is printed normally, and to prevent the additional data from being written to the first storing unit when the determining unit determines that the image is not printed normally.

Another aspect of the present invention provides an image-forming system including a writing unit, an image-forming unit, a determining unit, and a control unit. The writing unit writes additional data to a first storing unit of a recording medium and is capable of deleting the additional data from the first storing unit. The image-forming unit forms an image on the recording medium based on image data. The determining unit determines whether or not the image is normally printed on the recording medium by the image-forming unit. The control unit that controls the writing unit to delete the additional data from the first storing unit when the determining unit determines that the image is not printed normally, after the writing unit writes the additional data to the first storing unit.

Another aspect of the present invention provides an image-forming device including a writing unit, an image-forming unit, a determining unit, and a control unit. The writing unit is capable of writing additional data to a first storing unit of a recording medium. The image-forming unit forms an image on the recording medium based on image data. The determining unit determines whether or not the image is normally printed on the recording medium by the image-forming unit. The control unit controls the writing unit to write the additional data to the first storing unit when the determining unit determines that the image is printed normally, and to prevent the additional data from being written to the first storing unit when the determining unit determines that the image is not printed normally.

Another aspect of the present invention provides an image-forming device including a writing unit, an image-forming unit, a determining unit, and a control unit. The writing unit writes additional data to a first storing unit of a recording medium and is capable of deleting the additional data from the first storing unit. The image-forming unit forms an image on the recording medium based on image data. The determining unit determines whether or not the image is normally printed on the recording medium by the image-forming unit. The control unit that controls the writing unit to delete the additional data from the first storing unit when the determining unit determines that the image is not printed normally, after the writing unit writes the additional data to the first storing unit.

### BRIEF DESCRIPTION OF THE DRAWINGS

The particular features and advantages of the invention as well as other objects will become apparent from the following description taken in connection with the accompanying drawings, in which:

FIG. 1 is a block diagram showing an overall structure of a facsimile communication system according to a first embodiment of the present invention;

FIG. 2 is a cross-sectional view showing an internal structure of an MFP according to the first embodiment;

FIG. 3 is a flowchart illustrating steps in a facsimile transmission process;

FIG. 4 is a flowchart illustrating steps in a facsimile reception process according to the first embodiment;

FIG. 5 is a cross-sectional view showing an internal structure of an MFP according to a second embodiment of the present invention;

FIG. 6 is a flowchart illustrating steps in a facsimile transmission process according to the second embodiment;

FIG. 7 is a flowchart illustrating steps in a facsimile reception process according to the second embodiment;

FIG. 8 is a flowchart illustrating steps in a facsimile transmission process according to a third embodiment;

FIG. 9 is a flowchart illustrating steps in an incoming facsimile handling process according to a third embodiment;

FIG. 10 is a flowchart illustrating steps in a facsimile reception process in the incoming facsimile handling process of FIG. 9;

FIG. 11 is a flowchart illustrating steps in an RFID data requesting process according to the third embodiment;

FIG. 12 is a flowchart illustrating steps in an RFID data transmission process in the incoming facsimile handling process of FIG. 9; and

FIG. 13 is a flowchart illustrating steps in a writing/printing process according to a modification to the embodiments.

### DETAILED DESCRIPTION

### First Embodiment

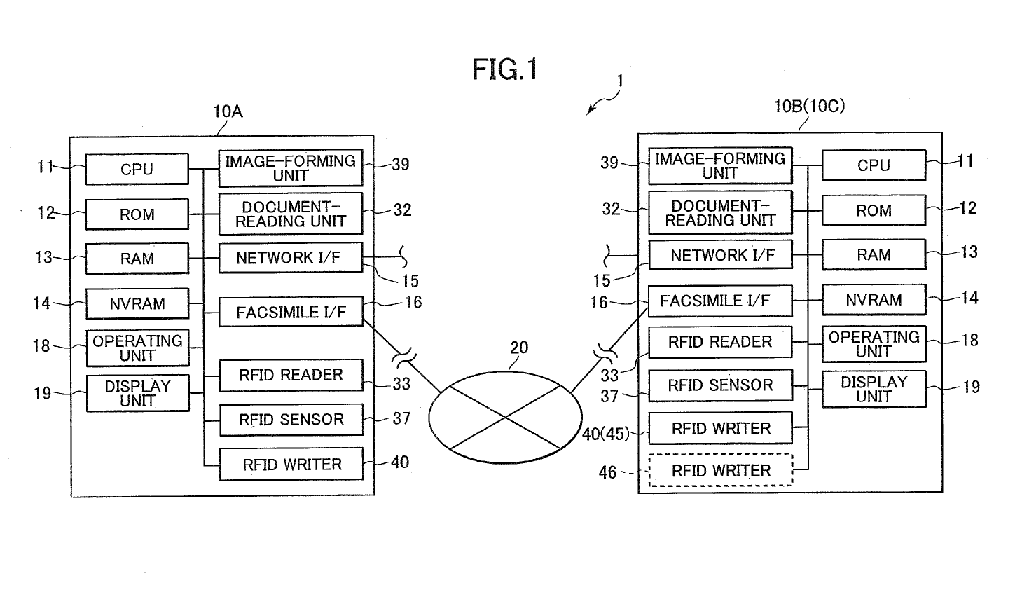

Next, an image forming system according to a first embodiment of the present invention will be described while referring to FIGS. 1 through 4.

(Overall Structure of Facsimile Communication System)

FIG. 1 is a block diagram showing the overall structure of a facsimile communication system 1 according to a preferred embodiment of the present invention. The facsimile communication system 1 is configured of two multifunction peripherals (MFPs) 10A and 10B, each having at least a facsimile communication function. The MFPs 10A and 10B are capable of exchanging facsimile data (image data) with each other. For the sake of simplicity, the following description will cover the process in which the MFP 10A transmits facsimile data to the MFP 10B, and the MFP 10B forms (prints) an image based on the facsimile data received from the MFP 10A. Accordingly, the MFP 10A will also be referred to as the transmission-side MFP 10A and the MFP 10B as the reception-side MFP 10B.

The hardware configurations of the MFPs 10A and 10B may differ, provided that both have at least a facsimile function. However, to simplify the description of the preferred embodiment, the MFPs 10A and 10B will share the same basic hardware configuration that includes a printer function, scanner function, and copier function in addition to the facsimile function. In the preferred embodiment, each of the MFPs 10A and 10B has a CPU 11, a ROM 12, a RAM 13, a NVRAM 14 (nonvolatile memory), a network interface 15, a facsimile interface 16, an operating unit 18, a display unit 19, an image-forming unit 39, a document-reading unit 32, a RFID reader 33, a RFID sensor 37, and a RFID writer 40.

The ROM 12 stores programs for executing various operations on the MFPs 10A and 10B, such as a facsimile transmission process and a facsimile reception process described later. The CPU 11 reads programs from the ROM 12 and executes the programs to perform various control processes while storing the results of operations in the RAM 13 or NVRAM 14. The network interface 15 connects the MFP 3 or 5 to an external computer (not shown) or the like via a network, enabling bi-directional communications between the two devices. The facsimile interface 16 connects the MFP 10A or 10B to another facsimile device via a public telephone network 20, enabling facsimile communications between the two devices.

The operating unit 18 includes a plurality of buttons by which the user can perform input operations. The display unit 19 includes a liquid crystal display and lamps for displaying configuration screens, the status of device operations, and the like. an image-forming unit 39, a document-reading unit 32, an RFID reader 33, an RFID sensor 37, and an RFID writer 40 will be described later in greater detail.

(Internal Structure of MFP)

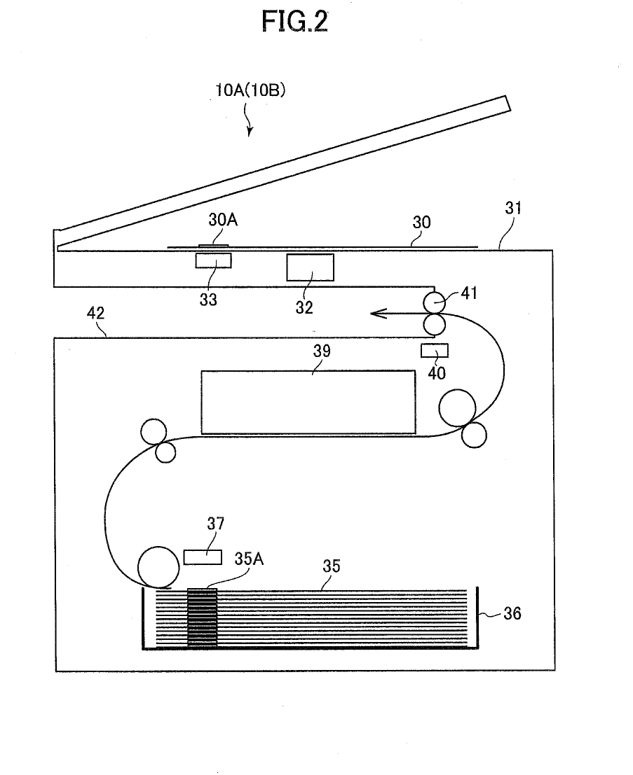

FIG. 2 is a cross-sectional view showing the basic internal structure of the MFP 10A. While the following description focuses on the MFP 10A, the MFP 10B has the same internal structure. As shown in FIG. 2, the MFP 10A includes a document bed 31 on which an original document 30 can be placed, and the document-reading unit 32 and RFID reader 33 disposed beneath the document bed 31. The document-reading unit 32 functions to scan and optically read an image on the original document 30 resting on the document bed 31 and to output image data generated based on the scanned image. The RFID reader 33 communicates with an RFID tag 30A attached to the original document 30 through radio waves in order to acquire data stored in the RFID tag 30A (hereinafter referred to as “RFID data”).

The MFP 10A is also provided with a paper tray 36 for accommodating a plurality of stacked sheets of paper 35. The paper 35 may include paper 35 with attached RFID tags 35A or paper 35 without attached RFID tags 35A. The RFID sensor 37 is disposed near the paper tray 36 and may be configured of an RFID reader, for example. The RFID sensor 37 emits a detection signal and detects whether the paper 35 loaded in the paper tray 36 has attached RFID tags 35A based on whether a response is received from the RFID tags 35A.

During a printing operation, the paper 35 is conveyed one sheet at a time from the paper tray 36 to an image-forming position of the image-forming unit 39. The image-forming unit 39 subsequently forms an image on the sheet of paper 35 using colorant (ink or toner) in one or a plurality of colors. After an image has been formed on the sheet of paper 35, the sheet passes through an access region of the RFID writer 40, and discharge rollers 41 discharge the sheet onto a discharge tray 42. While a sheet of paper 35 having the RFID tag 35A is conveyed from the image-forming position of the image-forming unit 39 to the discharge tray 42, the RFID writer 40 communicates with the RFID tag 35A through radio waves in order to write data to the RFID tag 35A.

(Facsimile Transmission Process)

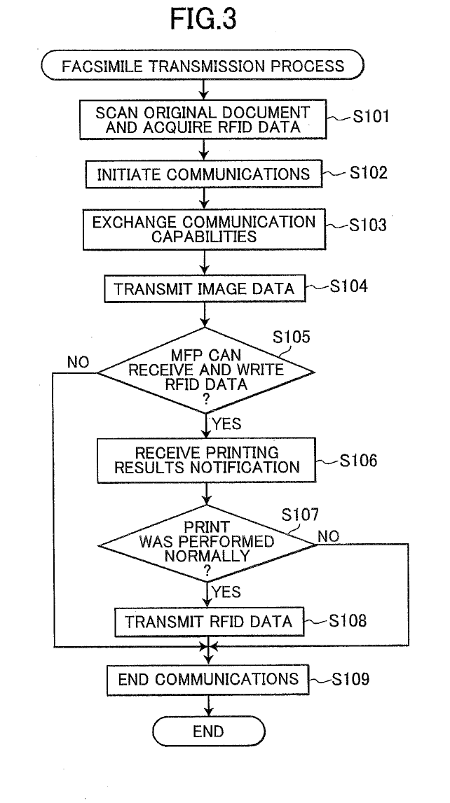

Next, a facsimile transmission process executed on the MFP 10A will be described. FIG. 3 is a flowchart illustrating steps in the facsimile transmission process.

The facsimile transmission process is executed when the user of the MFP 10A sets an original document 30 having an RFID tag 30A on the document bed 31 and inputs via the operating unit 18 both data indicating the destination of the transmission and an instruction to begin transmitting a facsimile for an original document with RFID data. In S101 at the beginning of the facsimile transmission process of FIG. 3, the CPU 11 of the MFP 10A controls the document-reading unit 32 to scan the original document 30 in order to acquire image data, controls the RFID reader 33 to read RFID data from the RFID tag 30A, and stores this data in the RAM 13 or the like. The RFID data stored in the RFID tag 30A of the original document 30 may include data identifying the original document 30 and data describing the original image on the original document 30, for example.

In S102 the CPU 11 issues a call from the facsimile interface 16 to the destination device (the MFP 10B in this example) through a telephone exchange (not shown) to initiate communications with the MFP 10B. In S103 the CPU 11 exchanges data indicating communication capabilities with the MFP 10B. Here, the CPU 11 not only sets a communication mode (transmission rate and the like) based on the communication capabilities of each device, but also receives data from the MFP 10B indicating whether the MFP 10B can currently receive and write RFID data.

In S104 the CPU 11 transmits the image data read from the original document 30 to the MFP 10B. In S105 the CPU 11 determines whether the MFP 10B can currently receive and write RFID data based on the data received from the MFP 10B. If the MFP 10B can currently receive and write RFID data (S105: YES), in 5106 the CPU 11 waits until a printing results notification has been received from the MFP 10B after the MFP 10B has printed the image data. The printing results notification includes data indicating whether the image data was printed successfully.

In S107 the CPU 11 determines whether the MFP 10B successfully printed the image data based on the printing results notification. If the print was performed normally (S107: YES), in 5108 the CPU 11 transmits the RFID data associated with the previously transmitted image data, and subsequently advances to S109. However, the CPU 11 does not transmit this RFID data when the MFP 10B could not print the image data successfully (S107: NO). In this way, the CPU 11 prevents the MFP 10B from writing RFID data when the image data could not be printed.

Further, if the CPU 11 determines in S105 that the MFP 10B cannot currently receive and write RFID data (S105: NO), the CPU 11 does not transmit the RFID data but skips to S109. In S109 the CPU 11 ends communications with the MFP 10B and subsequently ends the facsimile transmission process.

(Facsimile Reception Process)

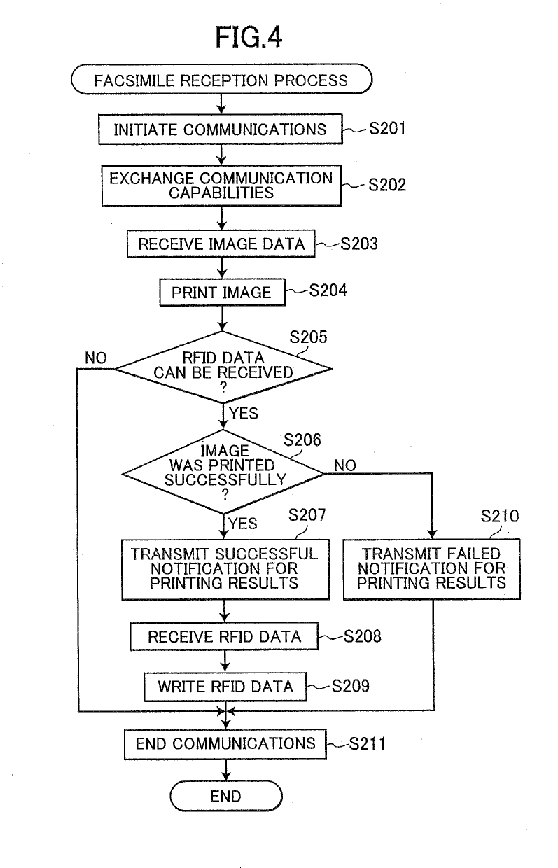

Next, a facsimile reception process executed on the MFP 10B will be described. FIG. 4 is a flowchart illustrating steps in the facsimile reception process.

The facsimile reception process on the MFP 10B begins when the facsimile interface 16 receives an incoming call from another device (the MFP 10A in this example) via a telephone exchange. In 5201 at the beginning of the facsimile reception process shown in FIG. 4, the CPU 11 initiates communications with the MFP 10A and in S202 exchanges data indicating communication capabilities with the MFP 10A. At this time, the CPU 11 determines whether or not the MFP 10B can currently receive and write RFID data, and transmits the results of this determination to the MFP 10A. In other words, the CPU 11 determines whether or not

Specifically, the CPU 11 controls the RFID sensor 37 to detect whether the paper 35 loaded in the paper tray 36 has RFID tag 35A attached thereto. The CPU 11 determines that the MFP 10B can currently receive and write RFID data when paper 35 having RFID tag 35A is loaded in the paper tray 36, and determines that the MFP 10B cannot receive and write RFID data when the paper 35 loaded in the paper tray 36 does not have RFID tag 35A. In other words, the CPU 11 judges that the RFID writer 40 is in an executable state when the paper 35 having RFID tag 35A is loaded in the paper tray 36, and that the RFID writer 40 is in an unexecutable state the paper 35 loaded in the paper tray 36 does not have RFID tag 35A.

In S203 the CPU 11 receives image data from the MFP 10A and in S204 controls the image-forming unit 39 to print an image based on the image data on a sheet of the paper 35 having a RFID tag 35A conveyed from the paper tray 36. In S205 the CPU 11 determines whether the notification sent to the MFP 10A in 5202 indicated that the MFP 10B can receive RFID data. If the MFP 10B cannot receive

RFID data (S205: NO), the CPU 11 jumps to S211 and ends communications with the MFP 10A.

However, if the notification sent to the MFP 10A indicated that the MFP 10B can receive RFID data (S205: YES), in 5206 the CPU 11 determines whether the image was printed successfully. Here, the CPU 11 determines that printing was not completed successfully when a paper jam or other error occurred before the printing operation was completed (before the sheet of paper 35 passed the image-forming position of the image-forming unit 39).

If the CPU 11 determines that the image was successfully printed (S206: YES), in 5207 the CPU 11 transmits printing results to the MFP 10A notifying the MFP 10A that the printing operation was completed successfully. In 5208 the CPU 11 receives RFID data from the MFP 10A in response to the notification (the printing results), and in S209 controls the RFID writer 40 to write this RFID data to the RFID tag 35A of the paper 35.

However, if the CPU 11 determines in S206 that the printing operation did not end successfully (S206: NO), in 5210 the CPU 11 transmits printing results to the MFP 10A notifying the MFP 10A that the printing operation was not completed successfully, and in S211 subsequently ends communications with the MFP 10A. Hence, if the MFP 10B could not print the image successfully, the CPU 11 does not write RFID data to the RFID tag 35A of the paper 35, since RFID data cannot be received from the MFP 10A.

After ending communications with the MFP 10A in 5211, the CPU 11 ends the facsimile reception process.

### Effects of First Embodiment

In the first embodiment described above, the MFP 10B writes

RFID data to the RFID tag 35A of the paper 35 after determining that image formation was completed successfully on a sheet of paper 35 having a RFID tag 35A, and restricts writing of RFID data upon determining that image formation was not completed successfully. Accordingly, the MFP 10B of the first embodiment avoids producing printed material (a sheet of paper) having only RFID data written to the RFID tag 35A when an image is not formed normally on the paper 35.

Further, the MFP 10B writes RFID data acquired from the RFID reader 33 of the MFP 10A after determining that an image based on image data acquired by the document-reading unit 32 of the MFP 10A was printed successfully. Accordingly, when duplicating both an image and RFID data read from an original document 30 having an RFID tag 30A (where duplication indicates printing image data received through facsimile communications on a sheet of paper 35 and writing RFID data received through facsimile communications to the RFID tag 35A of the paper 35), the first embodiment prevents creation of a duplicate having only RFID data written in the RFID tag when the image cannot be formed normally.

Further, the MFP 10A transmits RFID data to the MFP 10B, and the MFP 10B writes the RFID data under the condition that the MFP 10B successfully formed an image based on image data received from the MFP 10A. If both the image data and RFID data were transmitted together to the MFP 10B, there is a possibility that a duplicate having only the RFID data would be created if the image could not be formed properly. However, since the RFID data is transmitted only after determining that image formation was successful in the system of the preferred embodiment, the MFP 10B is prevented from producing a duplicate having only the RFID data.

### Second Embodiment

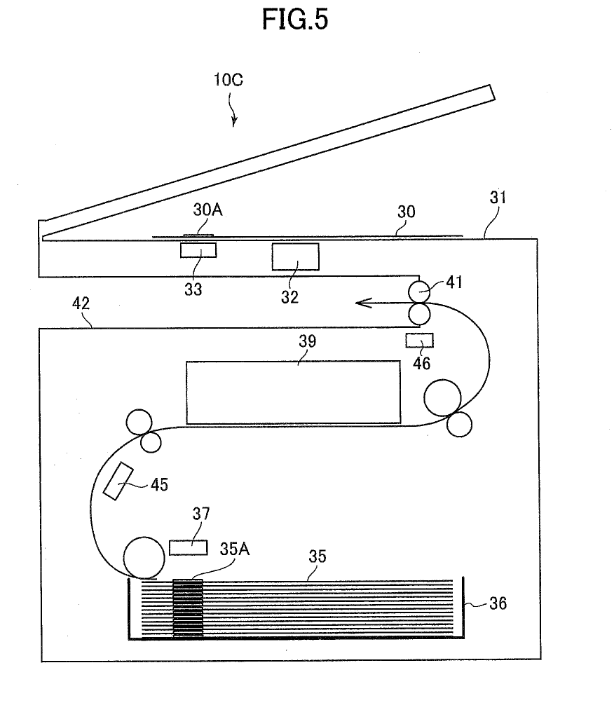

Next, an image forming system according to a second embodiment of the present invention will be described with reference to FIGS. 5 through 7. In the first embodiment described above, the transmission-side MFP does not transmit RFID data when the reception-side MFP could not print the image data successfully. However, in the facsimile communication system according to the second embodiment, the transmission-side MFP transmits both the image data and the RFID data to the reception-side MFP, and the reception-side MFP performs a printing operation and a writing operation based on this data. The reception-side MFP deletes the RFID data from the RFID tag when determining that the printing operation was not completed successfully.

(Internal Structure of MFP)

FIG. 5 is a cross-sectional view showing the basic internal structure of an MFP 10C. The facsimile communication system of the second embodiment is configured of the transmission-side MFP 10A shown in FIG. 1 and the reception-side MFP 10C shown in FIG. 5. In FIG. 5 parts and components of the MFP 10C identical to those in the MFP 10A are designated with the same reference numerals to avoid duplicating description.

The MFP 10C differs from the MFP 10A in that the MFP 10C is provided with an RFID writer 45 for writing data, and an RFID writer 46 for deleting data. The RFID writer 45 is disposed upstream of the image-forming position of the image-forming unit 39 and functions to write data to an RFID tag 35A of a sheet of paper 35 as the sheet is conveyed from the paper tray 36 to the image-forming position.

The RFID writer 46 is disposed downstream of the image-forming position and communicates with the RFID tag 35A of the paper 35 at a position downstream of the image-forming position in order to delete data that has been written to the RFID tag 35A.

(Facsimile Transmission Process)

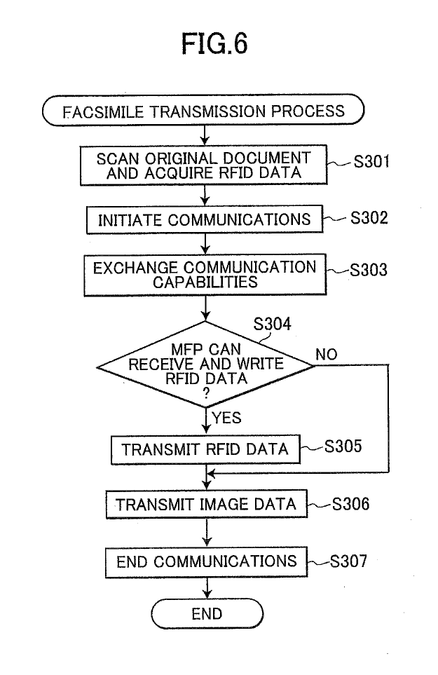

FIG. 6 is a flowchart illustrating steps in the facsimile transmission process executed on the MFP 10A.

The CPU 11 of the MFP 10A executes the facsimile transmission process when the user sets the original document 30 having the RFID tag 30A in the document bed 31 and inputs an instruction on the operating unit 18 to begin transmitting a facsimile with RFID data. In S301 at the beginning of the facsimile transmission process of FIG. 6, the CPU 11 controls the document-reading unit 32 to scan the original document 30 to acquire image data, controls the RFID reader 33 to read RFID data from the RFID tag 30A, and stores this data in the RAM 13 or the like.

In S302 the CPU 11 calls the destination device (the MFP 10C in this example) and initiates communications therewith. In S303 the CPU 11 exchanges data indicating communication capabilities with the MFP 10C. At this time, the CPU 11 also receives data indicating whether the MFP 10C can receive and write RFID data, from the MFP 10C. In S304 the CPU 11 determines whether the MFP 10C can receive and write RFID data. The CPU 11 transmits the RFID data in S305 if the MFP 10C can receive and write RFID data (S304: YES) and skips S305 without transmitting the RFID data when the MFP 10C cannot receive and write RFID data (S304: NO).

In S306 the CPU 11 transmits the image data to the MFP 10C. In S307 the CPU 11 ends communications with the MFP 10C, and subsequently ends the facsimile transmission process.

Since the transmission-side MFP 10A does not wait for printing results from the reception-side MFP 10C, as in the first embodiment, the facsimile transmission process according to the second embodiment can be completed in a relatively short time.

(Facsimile Reception Process)

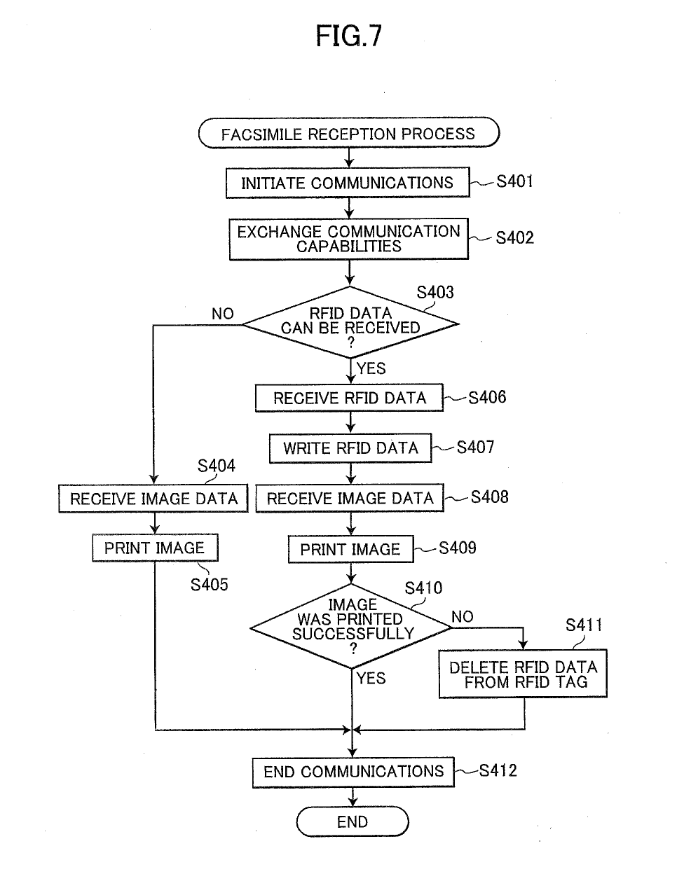

FIG. 7 is a flowchart illustrating steps in a facsimile reception process executed on the MFP 10C. The CPU 11 of the MFP 10C begins the facsimile reception process in FIG. 7 upon receiving an incoming call from another device (the MFP 10A in this example). In S401 at the beginning of the facsimile reception process, the CPU 11 initiates communications with the MFP 10A, and in S402 exchanges data indicating communication capabilities with the MFP 10A. At this time, the CPU 11 determines whether the MFP 10C is currently capable of receiving and writing RFID data and transmits data to the MFP 10A to notify the MFP 10A whether the MFP 10C can receive and write RFID data.

If the CPU 11 notified the MFP 10A that the MFP 10C cannot receive RFID data (S403: NO), in S404 the CPU 11 of the MFP 10C receives the image data from the MFP 10A, in S405 controls the image-forming unit 39 to print an image based on this image data on the paper 35, and in S412 ends communications with the MFP 10A. Thus, in this case the MFP 10A does not transmit RFID data and the MFP 10C does not write RFID data.

However, if the CPU 11 notified the MFP 10A that the MFP 10C can receive RFID data (S403: YES), in S406 the CPU 11 receives the RFID data from the MFP 10A and in S407 controls the RFID writer 45 to write this RFID data to the RFID tag 35A of the paper 35. In S408 the CPU 11 receives the image data from the MFP 10A and in S409 controls the image-forming unit 39 to print an image on the paper 35 based on this image data.

In S410 the CPU 11 determines whether the image was printed normally. If the image was not printed normally (S410: NO), in S411 the CPU 11 controls the RFID writer 46 to delete the RFID data from the RFID tag 35A of the paper 35. However, if the image was printed normally (S410: YES), the CPU 11 does not delete the RFID data in the RFID tag 35A.

Subsequently, in S412 the CPU 11 ends communications with the MFP 10A and, thereafter, ends the facsimile reception process.

### Effects of Second Embodiment

According to the second embodiment described above, the reception-side MFP 10C deletes RFID data previously written to the RFID tag 35A attached to a sheet of paper 35 upon determining that an image was not properly formed on the sheet. Accordingly, the system of the second embodiment can prevent the creation of printed material (a sheet of paper) having only RFID data written in the RFID tag when an image could not be formed properly on the sheet.

Further, the MFP 10C executes a write process to write RFID data acquired by the RFID reader 33 of the MFP 10A and subsequently deletes this RFID data upon determining that image formation based on image data acquired by the document-reading unit 32 of the MFP 10A could not be completed properly. Hence, when duplicating both an image scanned from an original document 30 and RFID data read from the RFID tag 30A of the original document 30, the system of the second embodiment can prevent the production of a duplicate having only the RFID data written in the RFID tag when the image could not be properly formed on the sheet.

Further, after the MFP 10C has written RFID data transmitted from the MFP 10A, the MFP 10C erases the RFID data upon determining that image formation based on image data received from the MFP 10A could not be completed properly. Accordingly, the MFP 10C can prevent the creation of duplicates having only RFID data.

### Third Embodiment

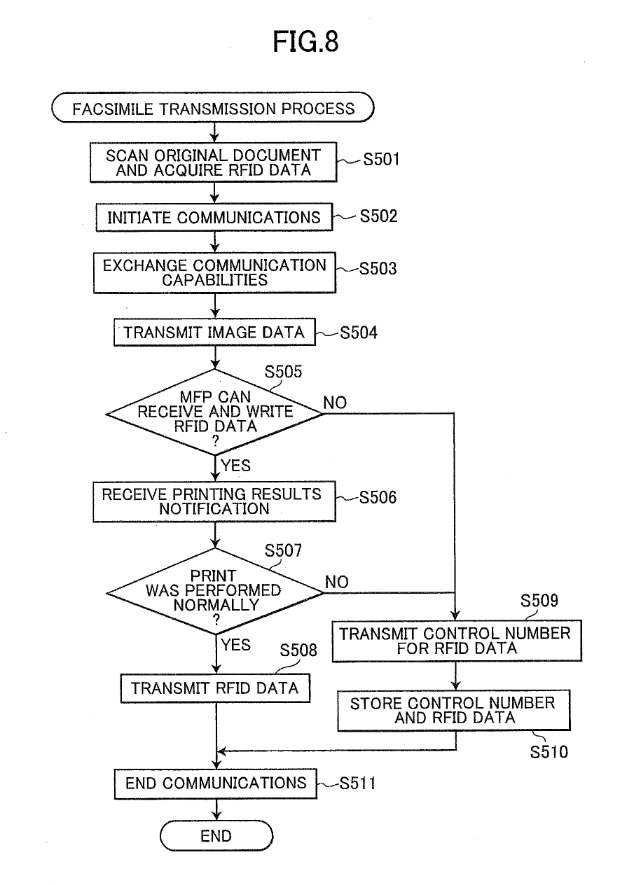

Next, an image forming system according to a third embodiment of the present invention will be described with reference to FIGS. 8 through 12. The structure of the facsimile communication system according to the third embodiment is identical to that shown in FIGS. 1 and 2. In the third embodiment, communications are ended after the MFP 10A has transmitted only image data to the MFP 10B when the MFP 10B cannot currently write RFID data. When the MFP 10B is capable of writing

RFID data in subsequent communications with the MFP 10A, the MFP 10A transmits the RFID data corresponding to the previously transmitted image data at this time.

(Facsimile Transmission Process)

FIG. 8 is a flowchart illustrating steps in the facsimile transmission process performed by the MFP 10A according to the third embodiment. The CPU 11 of the MFP 10A executes the facsimile transmission process when the user of the MFP 10A has set the original document 30 with an RFID tag 30A in the document bed 31 and has inputted an instruction to begin transmitting a facsimile having RFID data. In S501 at the beginning of the facsimile transmission process shown in FIG. 8, the CPU 11 controls the document-reading unit 32 to scan the original document 30 to acquire image data, controls the RFID reader 33 to read RFID data from the RFID tag 30A, and stores this data in the RAM 13 or the like.

In S502 the CPU 11 calls the destination device (the MFP 10B in this example) and initiates communications therewith. In S503 the MFP 10A exchanges data indicating communication capabilities with the MFP 10B. Here, the MFP 10A receives data indicating whether the MFP 10B can receive and write RFID data, from the MFP 10B. Subsequently, in S504 the CPU 11 transmits image data to the MFP 10B.

In S505 the CPU 11 determines whether the MFP 10B can receive and write RFID data based on the notification received in S503. When the MFP 10B can receive and write RFID data (S505: YES), in S506 the CPU 11 waits to receive a printing results notification indicating the results of printing the image data transmitted in S504, from the MFP 10B. In S507 the CPU 11 determines whether the image data was printed successfully based on the printing results notification. If so (S507: YES), in S508 the CPU 11 transmits the RFID data corresponding to the previously transmitted image data.

However, if the CPU 11 determines in S505 that the MFP 10C cannot receive and write RFID data (S505: NO) or if the image data was not printed successfully (S507: NO), in S509 the CPU 11 transmits a control number for the RFID data to the MFP 10B without transmitting the actual RFID data. This control number may be a unique number generated by the CPU 11, or an identification number or the like stored in the RFID tag 30A of the original document 30.

In S510 the CPU 11 stores the RFID data acquired in S501 in association with the control number in the NVRAM 14. In S511 the CPU 11 ends communications with the MFP 10B and subsequently ends the facsimile transmission process.

(Incoming Facsimile Handling Process)

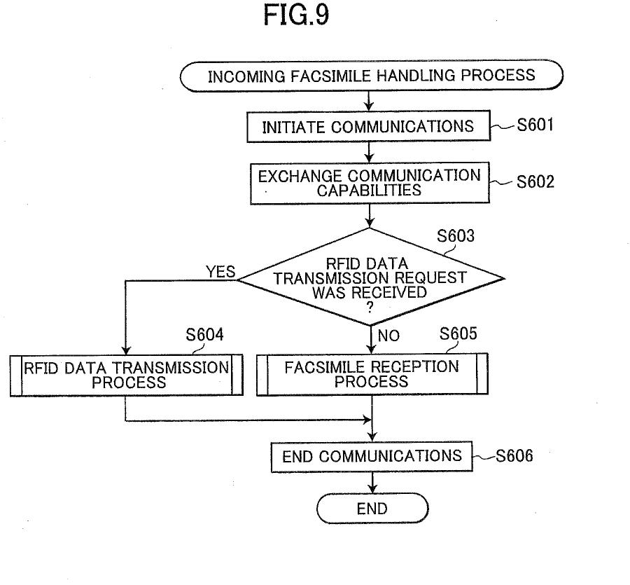

FIG. 9 is a flowchart illustrating steps in an incoming facsimile handling process. This process is executed on the MFP 10A or MFP 10B when one receives a call from the other via the facsimile interface 16.

In S601 at the beginning of the incoming facsimile handling process of FIG. 9, the CPU 11 of the MFP 10A or 10B initiates communications with the other MFP and in S602 exchanges data indicating communication capabilities with the other MFP. At this time, the MFP may either receive an RFID data transmission request described later from the other MFP or, when an RFID data transmission request was not received, may issue data (notification) indicating whether RFID data can be received, to the other MFP.

In S603 the CPU 11 determines whether an RFID data transmission request was received from the other MFP. If an RFID data transmission request was received (S603: YES), in S604 the CPU 11 executes an RFID data transmission process described later. However, if an RFID data transmission request was not received from the other MFP (S603: NO), in S605 the CPU 11 executes a facsimile reception process described later. Here, steps in the facsimile reception process executed on the reception-side MFP 10B will be described for a case in which the transmission-side MFP 10A calls the reception-side MFP 10B in the facsimile transmission process.

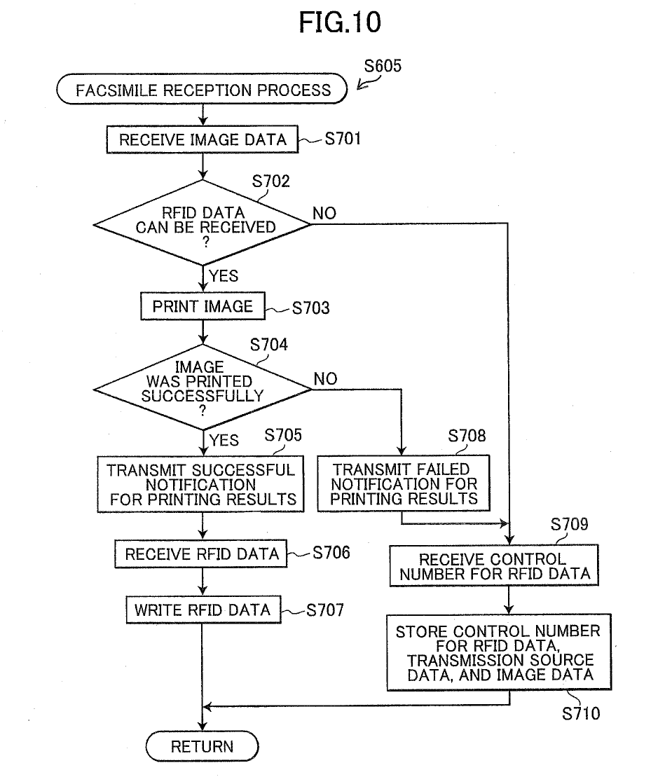

In S701 at the beginning of the facsimile reception process shown in FIG. 10, the CPU 11 of the MFP 10B receives image data from the MFP 10A. In S702 the CPU 11 determines whether the MFP 10B can receive RFID data based on the notification transmitted in S602. If the MFP 10B can receive RFID data (S702: YES), in S703 the CPU 11 prints the image data received in S701.

In S704 the CPU 11 determines whether the image was printed normally. If the image was printed normally (S704: YES), in S705 the CPU 11 transmits printing results to the MFP 10A indicating that the printing operation was completed successfully. In S706 the CPU 11 receives RFID data from the MFP 10A in response to the notification transmitted to the MFP 10A. In S707 the CPU 11 controls the RFID writer 40 to write the RFID data to the RFID tag 35A of the paper 35. However, if the image was not printed normally (S704: NO), in S708 the CPU 11 transmits printing results to the MFP 10A indicating that the printing operation was not completed successfully, and subsequently advances to S709.

When the MFP 10B is incapable of receiving RFID data at this time (S702: NO) or when the printing operation was not completed successfully (S704: NO), in S709 the CPU 11 receives the control number for the RFID data from the MFP 10A. In 5710 the CPU 11 stores this control number in the NVRAM 14 together with data indicating the MFP 10A as the source of the image data (transmission source data), and the actual image data received in S701. Subsequently, the CPU 11 returns to the process in FIG. 9, in S606 ends communications with the MFP 10A, and subsequently ends the incoming facsimile handling process.

(RFID Data Requesting Process)

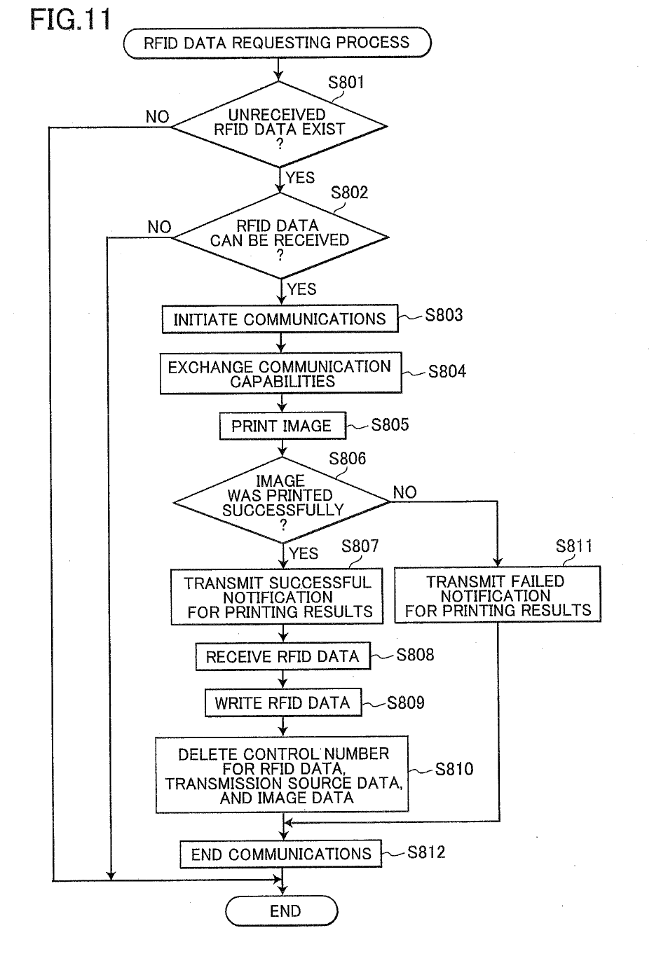

FIG. 11 is a flowchart illustrating steps in an RFID data requesting process for requesting the source of previously transmitted image data to transmit the corresponding RFID data when the RFID data was not previously received. This process is periodically executed on both the MFPs 10A and 10B. The following description will cover a case in which the MFP 10B executes the RFID data requesting process to request RFID data from the MFP 10A.

In S801 at the beginning of the RFID data requesting process shown in FIG. 11, the CPU 11 of the MFP 10B determines whether there exists RFID data not yet received. The CPU 11 makes this determination when a control number for RFID data is stored in the NVRAM 14. In this embodiment, the control number for RFID data is stored in the NVRAM 14 together with the transmission source data and the actual image data in S710 of the facsimile reception process as shown in FIG. 10. If unreceived RFID data does not exist (S801: NO), the CPU 11 ends the RFID data requesting process.

However, if unreceived RFID data exists (S801: YES), in S802 the CPU 11 determines whether the MFP 10B is in a state capable of receiving and writing RFID data. Here, the CPU 11 can determine that the MFP 10B is incapable of receiving RFID data when the RFID sensor 37 does not detect paper 35 having RFID tags 35A in the paper tray 36, for example. If the MFP 10B is incapable of receiving RFID data (S802: NO), the CPU 11 ends the RFID data requesting process.

However, if the CPU 11 determines that the MFP 10B is capable of receiving and writing RFID data (S802: YES), in S803 the CPU 11 reads the transmission source data corresponding to the control number for the unreceived RFID data from the NVRAM 14, calls the transmission source (the MFP 10A in this example) based on the transmission source data, and initiates communications with the MFP 10A. In S804 the CPU 11 exchanges data with the MFP 10A indicating communication capabilities. Here, the CPU 11 transmits an RFID data transmission request including the control number for the RFID data to the MFP 10A together with the communication capabilities data.

In S805 the CPU 11 reads the image data corresponding to the RFID data for which the RFID data transmission request was transmitted from the NVRAM 14 and prints an image based on this image data on a sheet of paper 35 having a RFID tag 35A. In S806 the CPU 11 determines whether the image was printed normally. If so (S806: YES), in S807 the CPU 11 transmits printing results to the MFP 10A notifying the MFP 10A that the printing operation was completed normally. In S808 the CPU 11 receives RFID data from the MFP 10A in response to the notification and in S809 controls the RFID writer 40 to write this RFID data to the RFID tag 35A of the paper 35. In 5810 the CPU 11 deletes the control number for the RFID data, the transmission source data, and the image data from the NVRAM 14.

However, if the CPU 11 determines in S806 that the printing operation was not completed normally (S806: NO), in 5811 the CPU 11 transmits printing results to the MFP 10A notifying the MFP 10A that the printing operation was not completed normally. In 5812 the CPU 11 ends communications with the MFP 10A and subsequently ends the RFID data requesting process.

(RFID Data Transmission Process)

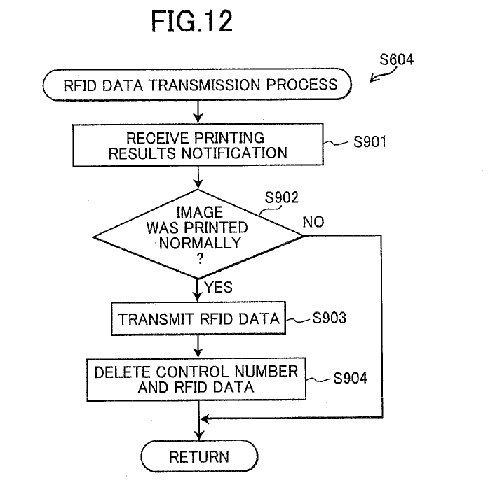

Next, the RFID data transmission process executed on the transmission-side MFP 10A when the MFP 10A receives an RFID data transmission request from the MFP 10B will be described with reference to FIG. 12.

The incoming facsimile handling process described above begins when the CPU 11 of the MFP 10A receives a call from the MFP 10B in S803 of the RFID data requesting process. If the CPU 11 of the MFP 10A receives an RFID data transmission request from the MFP 10B in S602 of the incoming facsimile handling process in FIG. 9 (S603: YES), in S604 the CPU 11 executes the RFID data transmission process of FIG. 12. In S901 of the RFID data transmission process shown in FIG. 12, the CPU 11 receives a printing results notification from the MFP 10B for image data printed by the MFP 10B.

In S902 the CPU 11 determines whether the image data was printed normally on the MFP 10B. If so (S902: YES), in S903 the CPU 11 reads RFID data from the NVRAM 14 corresponding to the control number included in the RFID data transmission request and transmits this RFID data to the MFP 10B. In S904 the CPU 11 deletes the RFID data and corresponding control number from the NVRAM 14 and subsequently returns to the incoming facsimile handling process of FIG. 9. In S606 of FIG. 9 the CPU 11 ends communications with the MFP 10B and subsequently ends the incoming facsimile handling process. However, if the image was not printed successfully (S902: NO), the CPU 11 ends the writing/printing process without reading and transmitting the RFID data.

### Effects of the Third Embodiment

In the system according to the third embodiment described above, RFID data is written to the RFID tag 35A of the paper 35 upon determining that image formation on the paper 35 was performed successfully, and RFID data is restricted from being written when the image formation was not completed normally. Accordingly, the system can prevent the formation of printed material having only RFID data written in the RFID tag when an image cannot be formed normally on the paper.

Further, the transmission-side MFP 10A ends communications with the reception-side MFP 10B after transmitting image data to the MFP 10B when the MFP 10B is incapable of writing RFID data. When communication with the MFP 10B is resumed while the MFP 10B is in a state capable of writing RFID data, the MFP 10A reads RFID data from the NVRAM 14 corresponding to the image data and transmits the RFID data to the MFP 10B. Since the MFP 10A does not transmit the RFID data to the MFP 10B when the MFP 10B is incapable of writing RFID data, the MFP 10A can prevent the MFP 10B from using the RFID data by itself. Further, by transmitting the image data alone to the MFP 10B in this case, the MFP 10A does not need to store the image data itself, thereby reducing the amount of data that must be stored on the MFP 10A.

### Variations of the Embodiments

While the invention has been described in detail with reference to specific embodiments thereof, it would be apparent to those skilled in the art that many modifications and variations may be made therein without departing from the spirit of the invention, the scope of which is defined by the attached claims.

(1) In the preferred embodiments described above, the image-forming system of the present invention is applied to a facsimile communication system. However, the present invention may also be applied to a standalone image-forming device, an image-forming system configured of a computer and a printer connected to the computer, and the like.

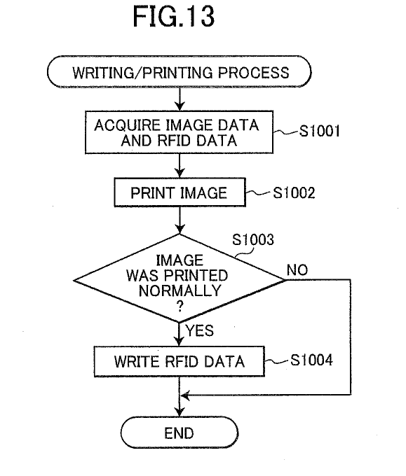

When using only a single MFP 10A having the structure shown in FIGS. 1 and 2 to create a duplicate of an original document 30 with a RFID tag 30A, the MFP 10A may execute a writing/printing process such as that shown in FIG. 13 when the user has set the original document 30 in the document bed 31 and has inputted an instruction on the operating unit 18 to create a copy of the original document 30. In S1001 of the writing/printing process, the CPU 11 of the MFP 10A controls the document-reading unit 32 to acquire image data from the original document 30 and controls the RFID reader 33 to acquire the RFID data from the RFID tag 30A. In S1002 the CPU 11 controls the image-forming unit 39 to print an image on a sheet of paper 35 having an RFID tag 35A based on the image data read in S1001. In S1003 the CPU 11 determines whether the image was printed normally. If so (S1003: YES), in S1004 the CPU 11 controls the RFID writer 40 to write the RFID data read in S1001 to the RFID tag 35A of the paper 35. However, if the image was not printed successfully (S1003: NO), the CPU 11 ends the writing/printing process without writing the RFID data.

The MFP 10A may also execute a writing/printing process such as that shown in FIG. 13 upon receiving a command from an external computer (not shown) via the network interface 15. In this case, in S1001 the CPU 11 may receive image data and RFID data from the external computer and may print an image based on this image data and write the RFID data received from the computer.

(2) The preferred embodiments describe a case in which the user sets one sheet of an original document on the document bed and the document-reading unit scans this single sheet. However, if the MFP is provided with an automatic document feeder (ADF), for example, the user may set a plurality of sheets of an original in the ADF, and the MFP may scan images and read RFID data from each sheet as the sheets are conveyed one at a time past a scanning position. Thus, the MFP can create a copy of a plurality of pages in one operation based on the data read from each sheet.

(3) When duplicating an image of an original document, the MFP of the present invention may form an image by partially modifying the image scanned from the original document (for example, by omitting a portion of the original image or adding a separate image to the original image). Further, when duplicating data acquired from a storage unit of the original document, the MFP of the present invention may write data to the duplicate that is partially modified from the original data (for example, by deleting a portion of the original data or adding separate data to the original data).

(4) In the preferred embodiments described above, the MFP determines whether an image was printed normally and only writes RFID data when the printing operation was completed normally. However, the MFP may determine that the printing operation was completed normally even before the image is completely printed when a different prescribed condition has been met, such as when a portion of the printing process has been completed normally (or another case in which the printing process is highly likely to be completed normally), and may write the RFID data upon determining that the printing operation is normal.

(5) In the preferred embodiments described above, the reception-side MFP determines whether RFID data can be written (whether the paper tray holds paper with RFID tag) and transmits data to the transmission-side MFP indicating whether RFID data can be received based on this determination. However, the reception-side MFP may also detect whether the paper tray has sufficient paper and whether the MFP (the image-forming unit 39) has sufficient ink or toner, for example, determine whether the image can be formed based on the results of these detections, and transmit data to the transmission-side MFP indicating whether RFID data can be received. In this case, the transmission-side MFP may transmit only the image data when the reception-side MFP is incapable of forming the image (when the reception-side MFP notifies the transmission-side MFP that RFID data cannot be received), as in the third embodiment described in FIGS. 8 through 12, and the reception-side MFP may subsequently request transmission of the RFID data upon returning to a state in which image formation is possible, such as after ink or the like has been replaced.

(6) In the third embodiment described above, the transmission-side MFP 10A ends communications with the reception-side MFP 10B after transmitting image data upon determining that the MFP 10B cannot write RFID data, and subsequently transmits RFID data to the MFP 10B when the MFP 10B calls and resumes communications with the MFP 10A and the MFP 10A determines that the MFP 10B can write RFID data. However, after ending communications with the MFP 10B, the MFP 10A may subsequently call and resume communications with the MFP 10B after a prescribed time has elapsed and may transmit the RFID data at that time upon determining that the MFP 10B is capable of writing RFID data.

What is claimed is:

1. An image-forming system comprising:
a writing unit that is capable of writing additional data to a first storing unit of a recording medium;
an image-forming unit that forms an image on the recording medium based on image data;
a determining unit that determines whether or not the image is normally printed on the recording medium by the image-forming unit; and
a control unit that controls the writing unit to write the additional data to the first storing unit when the determining unit determines that the image is printed normally, and to prevent the additional data from being written to the first storing unit when the determining unit determines that the image is not printed normally.

2. The image-forming system according to claim 1, further comprising:
an acquiring unit that acquires the additional data from a second storing unit of an original document; and
an image-reading unit that reads an original image on the original document to generate the image data,
wherein the image-forming unit forms the image on the recording medium based on the image data read by the image-reading unit, and
wherein the control unit controls the writing unit to write the additional data to the first storing unit when the determining unit determines that the image is printed normally.

3. The image-forming system according to claim 2, further comprising:
a transmitting unit that transmits the additional data and the image data;
a receiving unit that receives the additional data and the image data from the transmitting unit;
a first facsimile device that comprises the transmitting unit, the acquiring unit, and the image-reading unit; and
a second facsimile device that comprises the receiving unit, the writing unit, the image-forming unit, and the determining unit, and is in communication with the first facsimile device, and
wherein the control unit is included in at least one of the first facsimile device and the second facsimile device, and controls the transmitting unit to transmit the additional data to the receiving unit and the writing unit to write the additional data to the first storing unit when the determining unit determines that the image is printed normally.

4. The image-forming system according to claim 3, further comprising a communication control unit, and
wherein the first facsimile device further comprises a storage member that stores the additional data acquired by the acquiring unit,
wherein the second facsimile device further comprises the communication control unit and a judging unit that judges whether or not the writing unit is in an executable state,
wherein the communication control unit controls the transmitting unit to transmit the image data to the receiving unit and ends communications between the first facsimile device and the second facsimile device when the judging unit judges that the writing unit is not in the executable state, and
wherein, in subsequent communications, the communication control unit reads the additional data from the storage member and controls the transmitting unit to transmit the additional data corresponding to the image data to the receiving unit when the judging unit judges that the writing unit is in the executable state.

5. The image-forming system according to claim 3, further comprising a communication control unit, and
wherein the first facsimile device further comprises a storage member that stores the additional data acquired by the acquiring unit,
wherein the second facsimile device further comprises the communication control unit and a judging unit that judges whether or not the image-forming unit is in an executable state,
wherein the communication control unit controls the transmitting unit to transmit the image data to the receiving unit and ends communications between the first facsimile device and the second facsimile device when the judging unit judges that the image-forming unit is not in the executable state, and
wherein, in subsequent communications, the communication control unit reads the additional data from the storage member and controls the transmitting unit to transmit the additional data corresponding to the image data to the receiving unit when the judging unit judges that the image-forming unit is in the executable state.

6. An image-forming system comprising:
a writing unit that writes additional data to a first storing unit of a recording medium and is capable of deleting the additional data from the first storing unit;
an image-forming unit that forms an image on the recording medium based on image data;
a determining unit that determines whether or not the image is normally printed on the recording medium by the image-forming unit; and
a control unit that controls the writing unit to delete the additional data from the first storing unit when the determining unit determines that the image is not printed normally, after the writing unit writes the additional data to the first storing unit.

7. The image-forming system according to claim 6, further comprising:
an acquiring unit that acquires the additional data from a second storing unit of an original document; and
an image-reading unit that reads an original image on the original document to generate the image data,
wherein the image-forming unit forms the image on the recording medium based on the image data read by the image-reading unit, and
wherein the control unit controls the writing unit to delete the additional data from the first storing unit when the determining unit determines that the image is not printed normally, after the writing unit writes the additional data to the first storing unit.

8. The image-forming system according to claim 6, further comprising:
a transmitting unit that transmits the additional data and the image data;
a receiving unit that receives the additional data and the image data from the transmitting unit;
a first facsimile device that comprises the transmitting unit, the acquiring unit, and the image-reading unit; and
a second facsimile device that comprises the receiving unit, the writing unit, the image-forming unit, the control unit, and the determining unit, and is in communication with the first facsimile device, and
wherein the control unit controls the transmitting unit to transmit the additional data to the receiving unit and the writing unit to delete the additional data from the first storing unit when the determining unit determines that the image is not printed normally, after the writing unit writes the additional data to the first storing unit.

9. An image-forming device comprising:
a writing unit that is capable of writing additional data to a first storing unit of a recording medium;
an image-forming unit that forms an image on the recording medium based on image data;
a determining unit that determines whether or not the image is normally printed on the recording medium by the image-forming unit; and
a control unit that controls the writing unit to write the additional data to the first storing unit when the determining unit determines that the image is printed normally, and to prevent the additional data from being written to the first storing unit when the determining unit determines that the image is not printed normally.

10. An image-forming device comprising:
a writing unit that writes additional data to a first storing unit of a recording medium and is capable of deleting the additional data from the first storing unit;
an image-forming unit that forms an image on the recording medium based on image data;
a determining unit that determines whether or not the image is normally printed on the recording medium by the image-forming unit; and
a control unit that controls the writing unit to delete the additional data from the first storing unit when the determining unit determines that the image is not printed normally, after the writing unit writes the additional data to the first storing unit.
